(19) United States
(12) Patent Application Publication
(10) Pub. No.: US 2025/0361978 A1
(43) Pub. Date: Nov. 27, 2025

(54) MOUNTING DEVICE FOR A METAL PANEL

(71) Applicant: RMH TECH LLC, Colorado Springs, CO (US)

(72) Inventor: Jonathon Moss, Grandview, TX (US)

(21) Appl. No.: 19/213,755

(22) Filed: May 20, 2025

Related U.S. Application Data
(60) Provisional application No. 63/650,316, filed on May 21, 2024.

(51) Int. Cl. F16M 13/02; F16B 2/06

(52) U.S. Cl. CPC F16M 13/02; F16B 2/065

(57) ABSTRACT

A mounting device for a metal panel includes a body and an insert. A fastener engages the body and/or the insert to secure the body and the insert together. The body sits on a panel projection of the metal panel and the insert is positioned within the panel projection when the mounting device is installed on the panel projection. Pivoting or rotating the insert relative to the body (i.e., during coupling via the fastener) via engagement of a notch in the body by a protrusion on the insert causes the body and the insert to be secured to the panel projection. A throat of the body is contoured to conform to multiple different configurations of the panel projection. Additional structure is couplable to the panel projection via an aperture on the mounting device, after the mounting device is installed on the panel projection.

### CROSS-REFERENCE TO RELATED APPLICATION

This application claims the benefit of priority under 35 U.S.C. § 119 (e) to U.S. Provisional Patent Application No. 63/650,316, filed on May 21, 2024, the entirety of which is incorporated herein by reference.

### FIELD

The disclosure relates to a mounting device or a clamp configured to be secured to a projection extending from a metal panel defining a roof or a sidewall of a building.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Metal panels are frequently used to construct parts of buildings such as roofs and sidewalls. During construction, adjacent panels are connected at joints, which are weatherproof and protect the building from the external environment. One type of joint is a standing seam joint that extends or protrudes away from the main surfaces of the panels. The standing seam mechanically joins two adjacent metal panels. These seamed joints may have many different configurations, including a single fold, a double fold, a snap lock, a nail strip, a batten cap, a T-seam, a bulb seam, and a snap seam. Some metal panels have ribs that extend from the panel. The ribs are located between seams that join the metal panel to adjacent metal panels.

It is often desirable to install various types of auxiliary structures or components such as heating units, air conditioning units, ventilation equipment, solar panels or other photovoltaic equipment, snow retention systems, and the like on metal panels, particularly metal panels used to form a roof. These structures can be secured to the metal panel with fasteners. However, installing structures on the roof in a manner that punctures the metal panel, or which requires the formation of a hole through the metal panel, is undesirable. Puncturing the metal panel or a roof joint with a fastener that forms or requires a hole presents leakage and corrosion issues for the roof, and holes in the metal panel are aesthetically displeasing. In addition, forming holes through a metal panel may void a warranty provided by the manufacturer. Further, select metal roof panels are of a thickness that puncturing with a fastener is not feasible.

Mounting devices can provide a location for these structures to mount to a roof. Typically, a mounting device is secured to a fold, a joint, or a seam between two metal panels or to a rib extending from a metal panel (collectively referred to herein as “a panel projection”) without puncturing the metal panel. A structure may then be connected to the mounting device. Mounting devices can be secured to the roof by squeezing or clamping to the panel projection that extends away from the roof.

Other mounting devices include set screws or other threaded fasteners that are driven against a portion of the panel projection (such as against a sidewall). As the fastener is driven against the panel projection, rotation of the end of the fastener against the panel projection can scratch the metal panel or damage protective coatings on the metal panel. Another problem is that the fastener may bend or deform the panel projection. Further, for mounting devices configured to engage a roof joint (such as a snap seam), it may not be feasible for a fastener driven against the roof joint to squeeze the roof joint to an extent that the mounting device is secured to the roof.

### SUMMARY

As such, there exists a need for a mounting device that can be secured to a panel projection quickly and easily without needing to interface with the panel projection via engagement by a fastener to the panel projection. The mounting device should be economical to produce. The mounting device should be able to interface with multiple configurations of panel projections, to promote increased usability across a product line and available roof options.

Embodiments of the present disclosure are directed to a mounting device for a panel projection of a metal panel. The mounting device is a clamp that includes a body and an insert that engage to form an assembly.

In embodiments, the body has a cavity or throat to receive an upper surface or upper section of a panel projection. The cavity or throat is defined in part by a first arm, a second arm, and a first wall therebetween.

In embodiments, the insert has a first leg, a second leg or trunk, and a second wall therebetween. The first leg, the second leg or trunk, and the second wall at least partially define a cavity. For example, the cavity defined by the insert may receive a portion of the body including, but not limited to, the first arm. The trunk is insertable into a cavity defined by a lower surface or lower section of the panel projection.

Engagement of the panel projection by the throat of the body and the trunk of the insert secures the mounting device to the panel projection. For example, at least one surface of the throat of the body may engage a corresponding upper or superior surface (or section) of the panel projection. In addition, a surface of the trunk of the insert may engage a corresponding lower or inferior surface (or section) of the panel projection. This engagement causes the mounting device to secure onto the panel projection via a clamping motion, where the panel projection is secured between the throat of the body and the trunk of the insert.

In embodiments, the body has a notch into which a protrusion of the insert may be positioned during installation of the mounting device onto the panel projection. In some configurations, the protrusion within the notch is utilized to assist in maintaining a connection between the body and the insert during installation of the mounting device on the panel projection, such that a single installer may perform the necessary operations to couple the mounting device to the panel projection.

Complementary surfaces of the notch and the protrusion are set at an oblique angle to one another, to allow the protrusion to pivot or rotate within the notch about an axis through the body proximate to the notch during installation. Various complementary surfaces of the body and the insert are similarly set at an oblique angle to one another, to further promote the pivoting or rotating motion of the protrusion within the notch.

Optionally, the body and the insert are coupled together via a fastener. The body has a first aperture, into which the fastener is inserted after passing through a second aperture in the insert. In some embodiments, at least one of the first aperture and the second aperture are threaded, with the fastener being either fully threaded from proximal head to distal tip, or including a first (i.e., proximal) portion that is a smooth shank and a second (i.e., distal) portion that is threaded. In other embodiments, neither the first aperture nor the second aperture is threaded, and the fastener engages with a second fastener (e.g., a nut, cotter pin, etc.) once the fastener passes through both the first aperture and the second aperture.

In one non-limiting example, the first aperture may be threaded, and the second aperture may be smooth-bore. The smooth-bore second aperture may be a slot with a major axis and a minor axis. In some instances, the minor axis is substantially equal in diameter to an outer diameter of the fastener (i.e., a major diameter defined by a distance between thread peaks on the fastener, or an outer diameter of a smooth-bore fastener), while the major axis is greater in diameter to the outer diameter of the fastener.

The pivoting or rotating motion of the insert relative to the body (i.e., via the engagement of the notch in the body by the protrusion of the insert) may be driven in part by a force applied on the insert by the installation of the fastener into the first aperture and the second aperture. In some embodiments, the slot configuration for the second aperture allows for the fastener to move within the insert during installation. For example, passing the fastener through the second aperture and into the first aperture causes the fastener to press against an exterior surface of the insert when the fastener is secured to the body (e.g., by complementary threading on the first aperture and the fastener, or via a nut or cotter pin that couples to the fastener once the fastener passes through the first aperture, etc.) Continued securing of the fastener to the body and against the insert causes the insert to pivot or rotate relative to the body via the corresponding protrusion and notch. With the slot configuration for the second aperture, the fastener is able to move within the second aperture during the tightening to promote the pivoting or rotating motion between the corresponding protrusion and notch.

As the insert is coupled to the body (i.e., via the fastener), the at least one surface of the throat of the body is drawn onto the corresponding upper or superior surface (or section) of the panel projection. In addition, the surface of the trunk of the insert is drawn into the lower or inferior surface (or section) of the panel projection. For example, the drawing of the throat onto the panel projection and/or the drawing of the insert into the panel projection is accomplished at least in part by the pivoting or rotating of the insert relative to the body via the engagement of the protrusion of the insert and the notch of the body.

In some embodiments, the at least one surface of the throat of the body is contoured to conform to the upper or superior surfaces (or sections) of a number of different panel projections. For example, the body may be contoured to conform to the upper or superior surfaces (or sections) of at least a first panel projection and a second panel projection. In some instances, the first panel projection and the second panel projection may be configured with different cross-sections, and the throat of the body is contoured to conform to at least a portion of both of the different cross-sections.

In other embodiments, the at least one surface of the throat of the body is specific to a particular corresponding upper or superior surface (or section) of the panel projection. In these embodiments, depending on the particular configuration of the panel projection, one or more of width or height of the at least one surface of the throat of the body may be modified or altered (i.e., during design and fabrication when manufacturing the mounting device) to conform to the particular configuration of the panel projection.

In embodiments, the body includes an aperture within the first wall. The aperture is configured to allow a photovoltaic assembly or other auxiliary structure or component to be secured to the mounting device, after the mounting device is secured to the panel projection. The mounting device thus forms the connection between the panel projection and the photovoltaic assembly or other auxiliary structure or component. The aperture within the first wall may be any depth within the first wall, including a partial depth such that it ends within the first wall or a full depth such that it exits into the throat or cavity of the body. It should be understood, however, that the aperture in the first wall of the body is configured (i.e., located within the first wall, dimensioned, etc.) so as to not interfere with the engagement of the throat of the body to the upper or superior surfaces of the panel projection.

A first aspect of the present disclosure is to provide a mounting device for a metal panel. The mounting device comprises a body comprising an arm with a first aperture, the body including at least one interior surface that defines a throat; an insert comprising a leg and a trunk, the leg including a second aperture; and a fastener insertable through the second aperture of the insert and into the first aperture of the body. Insertion of the fastener into the second aperture of the insert and the first aperture of the body causes the throat of the body to engage a first surface of a panel projection of the metal panel when the mounting device is positioned on the metal panel. Insertion of the fastener into the second aperture of the insert and the first aperture of the body causes the trunk of the insert to engage a second surface within a cavity of the panel projection of the metal panel.

The mounting device of the first aspect may include, optionally, that the arm of the body includes a notch, the leg of the insert includes a protrusion, and the protrusion is insertable into the notch of the body.

The mounting device of the first aspect may include one or more of the previous embodiments and, optionally, that a first side surface of the arm of the body and a second side surface of the leg of the insert are set at an oblique angle when the throat is engaged to the first surface and the trunk is engaged to the second surface.

The mounting device of the first aspect may include one or more of the previous embodiments and, optionally, that the throat comprises a base surface, and the base surface and a proximal end of the trunk define a gap in which the panel projection is positioned when the mounting device is installed on the metal panel.

The mounting device of the first aspect may include one or more of the previous embodiments and, optionally, that the throat comprises a first side surface, a second side surface, a base surface, a third side surface, a fourth side surface, and a fifth side surface.

The mounting device of the first aspect may include one or more of the previous embodiments and, optionally, that one or more of the first side surface, the second side surface, the base surface, the fourth side surface, and the fifth side surface engage the first surface of the panel projection of the metal panel when the mounting device is positioned on the metal panel, and a proximal end of the trunk engage the second surface of the panel projection.

The mounting device of the first aspect may include one or more of the previous embodiments and, optionally, that at least the base surface and the third side surface engage the first surface of the panel projection of the metal panel when the mounting device is positioned on the metal panel, and a proximal end of the trunk engages the second surface of the panel projection.

The mounting device of the first aspect may include one or more of the previous embodiments and, optionally, that the first aperture has threading that is complementary to threading on the fastener, the threading of the fastener has a thread pitch, and the first aperture has a length at least two times greater than the thread pitch.

The mounting device of the first aspect may include one or more of the previous embodiments and, optionally, that the second aperture in the insert is an elongated slot.

The mounting device of the first aspect may include one or more of the previous embodiments and, optionally, the body further comprises a wall with a third aperture for installing a structure onto the mounting device after the mounting device is installed on the panel projection of the metal panel.

The mounting device of the first aspect may include one or more of the previous embodiments and, optionally, the body further comprises a second arm opposite the arm, where an upper surface of the wall and an exterior surface of the second arm are substantially perpendicular, and where the exterior surface of the second arm is substantially planar.

A second aspect of the present disclosure is to provide a mounting device for a metal panel. The mounting device comprises a body comprising an arm with a notch, the body including at least one interior surface that defines a throat; and an insert comprising a leg and a trunk, the leg including a protrusion. The body and the insert are rotatable between a first orientation and a second orientation when the protrusion is positioned within the notch of the body. The body and the insert being in the first orientation causes the insert to be disengaged from a panel projection of the metal panel. The body and the insert being in the second orientation causes the throat of the body to engage a first surface of the panel projection, and the trunk of the insert to engage a second surface within a cavity of the panel projection of the metal panel.

The mounting device of the second aspect may include, optionally, the body comprises a tab located above the arm, the tab including a lower surface that at least partially defines the notch.

The mounting device of the second aspect may include one or more of the previous embodiments and, optionally, that an upper surface of the protrusion and a lower surface of the tab are set at an oblique angle when the protrusion is inserted in the notch and the body is in the first orientation.

The mounting device of the second aspect may include one or more of the previous embodiments and, optionally, that the body includes a first aperture in the arm and the insert includes a second aperture in the leg, and the mounting device further comprises a fastener extendable through the second aperture and insertable into the first aperture to cause the body and the insert to transition between the first orientation and the second orientation.

The mounting device of the second aspect may include one or more of the previous embodiments and, optionally, that the notch includes a first pivot corner, the protrusion includes a second pivot corner, and the first pivot corner and the second pivot corner engage during a rotating of the body and the insert between the first orientation and the second orientation about an axis proximate to the first pivot corner.

A third aspect of the present disclosure is to provide a mounting device to engage a panel projection extending from a metal panel. The mounting device comprises a body including a first aperture that is threaded, a notch, and a throat; an insert including a second aperture that is an elongated slot, a protrusion, and a trunk, wherein the protrusion is insertable into the notch of the body; and a fastener insertable through the second aperture of the insert and into threaded engagement with the first aperture of the body. The body and the insert are rotatable between a first orientation and a second orientation when the protrusion is inserted into the notch. The body and the insert being in the first orientation causes a gap between an end of the trunk and a base surface of the body to be a first magnitude. The body and the insert being in the second orientation causes the gap between the end of the trunk and the base surface of the body to be a second magnitude that is less than the first magnitude. When the fastener is inserted through the second aperture of the insert and into threaded engagement with the first aperture of the body, rotation of the fastener causes the body and the insert to move into the first orientation.

The mounting device of the third aspect may include, optionally, wherein an arm of the body includes the first aperture and the notch, and wherein a leg of the insert includes the second aperture and the protrusion.

The mounting device of the third aspect may include one or more of the previous embodiments and, optionally, further comprising a tab located above the arm, the tab including a lower surface that at least partially defines the notch.

The mounting device of the third aspect may include one or more of the previous embodiments and, optionally, wherein an upper surface of the protrusion is set at an oblique angle to a first side surface of the leg, and wherein a lower surface of the tab is set at an oblique angle to an upper surface of the body.

The mounting device of the third aspect may include one or more of the previous embodiments and, optionally, wherein the fastener has exterior threading with a thread pitch, and wherein the first aperture has a length at least two times greater than the thread pitch.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

As used herein, two edges (i.e., lines) or surfaces being “substantially parallel” are set at an angle of approximately 0° or 180°. In addition, two edges (i.e., lines) or surfaces being “substantially perpendicular” are set at an angle of approximately 90°. Further, two edges (i.e., lines) or surfaces being at an “oblique angle” are set at an angle that is approximately non-zero, or in general, an angle that is neither “substantially parallel” nor “substantially perpendicular.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112 (f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the disclosure given above and the detailed description of the drawings given below, serve to explain the principles of the disclosure.

FIG. 1A illustrates a perspective view of a mounting device including a body, an insert, and a fastener, in accordance with one or more embodiments of the present disclosure;

FIG. 1B illustrates a front elevation view of the mounting device of FIG. 1A;

FIG. 1C illustrates a rear elevation view of the mounting device of FIG. 1A;

FIG. 1D illustrates a top plan view of the mounting device of FIG. 1A, with section line 2-2;

FIG. 1E illustrates a bottom plan view of the mounting device of FIG. 1A;

FIG. 1F illustrates a left elevation view of the mounting device of FIG. 1A;

FIG. 1G illustrates a right elevation view of the mounting device of FIG. 1A;

FIG. 2 illustrates a cross-section view of the mounting device of FIG. 1A at the section line 2-2 in FIG. 1D;

FIG. 3A illustrates a perspective view of the body of the mounting device of FIG. 1A, in accordance with one or more embodiments of the present disclosure;

FIG. 3B illustrates a front elevation view of the body of FIG. 3A;

FIG. 3C illustrates a rear elevation view of the body of FIG. 3A;

FIG. 3D illustrates a top plan view of the body of FIG. 3A, with section line 4-4;

FIG. 3E illustrates a bottom plan view of the body of FIG. 3A;

FIG. 3F illustrates a left elevation view of the body of FIG. 3A;

FIG. 3G illustrates a right elevation view of the body of FIG. 3A;

FIG. 4 illustrates a cross-section view of the body of FIG. 3A at the section line 4-4 in FIG. 3D;

FIG. 5A illustrates a perspective view of the insert of the mounting device of FIG. 1A, in accordance with one or more embodiments of the present disclosure;

FIG. 5B illustrates a front elevation view of the insert of FIG. 5A;

FIG. 5C illustrates a rear elevation view of the insert of FIG. 5A;

FIG. 5D illustrates a top plan view of the insert of FIG. 5A, with section line 6-6;

FIG. 5E illustrates a bottom plan view of the insert of FIG. 5A;

FIG. 5F illustrates a left elevation view of the insert of FIG. 5A;

FIG. 5G illustrates a right elevation view of the insert of FIG. 5A;

FIG. 6 illustrates a cross-section view of the insert of FIG. 5A at the section line 6-6 in FIG. 5D;

FIG. 7A is an environment view of the mounting device of FIG. 1A coupled to a first panel projection, in accordance with one or more embodiments of the present disclosure;

FIG. 7B is an environment view of the mounting device of FIG. 1A coupled to a second panel projection, in accordance with one or more embodiments of the present disclosure; and

FIG. 8 illustrates a flow diagram of a method or process for the operation and use of the mounting device of FIG. 1A, in accordance with one or more embodiments of the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure.

### Reference Number Component

100 Mounting Device
102 Body
104 Insert
106 Fastener
107 Head
109 Shaft
108 First Arm
110 Second Arm
112 Wall
114 Throat or Cavity
116 First Leg
118 Trunk or Second Leg
120 Wall
122 Cavity
124 Side Surface
126 Notch
128 Side Surface
130 Protrusion
132 Angle
134 Tab
136 Surface
138 Surface
140 Angle
200 Gap
300 Upper Surface
302 First Bottom Surface
304 Second Bottom Surface
306 Side Surface
308 Front Surface
310 Rear Surface
312 Aperture
314 Side Surface
316 Aperture
318 Base Surface
320 Side Surface
322 Side Surface
324 Side Surface
326 Side Surface
327 Width
330 Height
332 Length
334 Side Surface
336 Width
338 Lower Surface
340 Upper Surface
342 Inset Surface
344 Pivot Corner
400 First Width
402 Second Width
404 Height
500 Lower Surface
502 Upper Surface
504 Upper Surface (or Proximal End)
506 Side Surface
508 Side Surface
510 Side Surface
512 Front Surface
514 Rear Surface
516 Aperture
518 Base Surface
520 Side Surface
522 Side Surface
524 Side Surface
526 Length
528 Height
530 Lower Surface
532 Pivot Corner
600 First Width
602 Second Width
604 Height
606 Corner
700 Metal Panel
702 Panel Projection
704 Upper Section
704A Upper Surface
706 Lower Section
706A Lower Surface
708 Panel Projection End
710 Projection Cavity
800 Method or Process
802 Position a Body of a Mounting Device on a Panel Projection
804 Position an Insert of the Mounting Device with a Cavity Defined by the Panel Projection
806 Position a Protrusion of the Insert with a Notch of the Body
808 Couple the Insert to the body with a Fastener
810 Couple the Body and the Insert to the Panel Projection

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the mounting device would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the mounting device can be combined with dimensions, aspects, and features of another embodiment of the mounting device to create the claimed embodiment.

In general, embodiments of the present disclosure are directed to a mounting device for a metal panel. Embodiments of the present disclosure are also directed to a body and an insert for the mounting device. Embodiments of the present disclosure are also directed to securing the body and the insert together with a fastener that engages the body and/or the insert. Embodiments of the present disclosure are also directed to installing the mounting device on a panel projection of the metal panel, such that the body sits on the panel projection and the insert is positioned at least partially within the panel projection. Embodiments of the present disclosure are also directed to pivoting or rotating the insert relative to the body (i.e., during coupling via the fastener) via engagement of a notch in the body by a protrusion on the insert, to cause the body and the insert to be secured to and/or on the panel projection. Embodiments of the present disclosure are also directed to the throat of the body being contoured to conform to multiple different configurations of the panel projection. Still another embodiment of the present disclosure is a mounting device comprising a body and an insert in which an upper surface of the body is generally planar and the body and the insert are coupled together by a fastener that extends through side surfaces of the body and the insert such that the planar upper surface of the body is free from projections to support objects to be secured to the mounting device.

As such, the embodiments of the present disclosure are directed to the ability to couple the mounting device to a metal panel including a panel projection, including such as one that cannot be punctured through a force applied on the metal panel by the mounting device but may optionally be compressed. The coupling of the mounting device to the metal panel occurs via the optional compression of portions of a panel projection of the metal panel between the body and the insert of the mounting device.

In some embodiments, the mounting device of the present disclosure is a solution for metal panels (i.e., such as a structural seam roof or sidewall) that are of an increased thickness and/or that have multiple optionally compressive layers, where the metal panels are larger and more robust surface than typical metal panels for roof structures. In particular, the metal panels may not have a sub-structure such that the metal panel is considered part of a structure instead of installed on a structure. Such a metal panel may have a panel projection that is enclosed and not reasonably able to be breached (i.e., via a penetrating fastener). Traditional solutions for such a metal panel are known to be expensive and similar to a panel clamp, which are not tailor-fit for any intended use as compared to the mounting device of the present application.

In some configurations, the metal panels to which the mounting device of the present disclosure is couplable may not have a sufficient vertical leg or surface to which a set screw may engage for attachment of the mounting device (i.e., as with some known solutions). In addition, using a set screw to engage a horizontal surface when securing the mounting device may interfere with the insertion of a second fastener to couple an auxiliary structure or component (i.e., heating units, air conditioning units, ventilation equipment, solar panels or other photovoltaic equipment, snow retention systems, and the like) to the mounting device. As such, the mounting device of the present disclosure employs a fastener in a vertical or side surface to secure the mounting device, while engaging a top geometry and a bottom geometry of the panel projection with the mounting device.

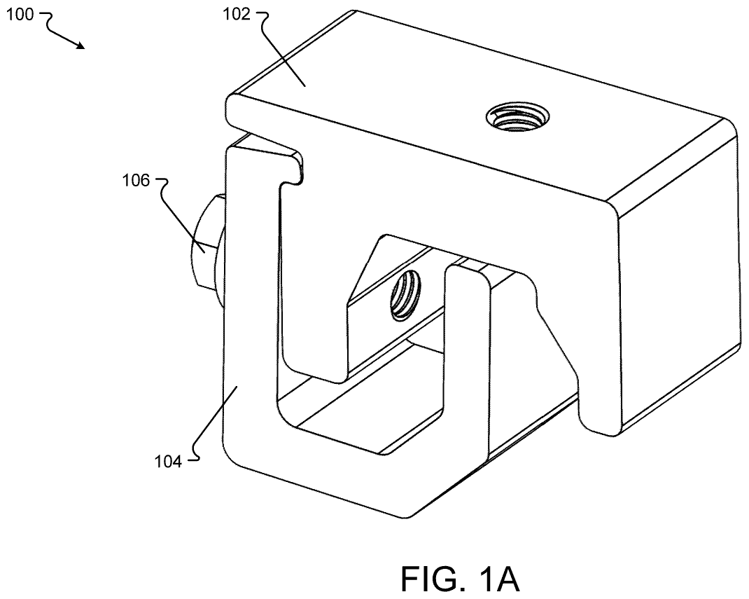

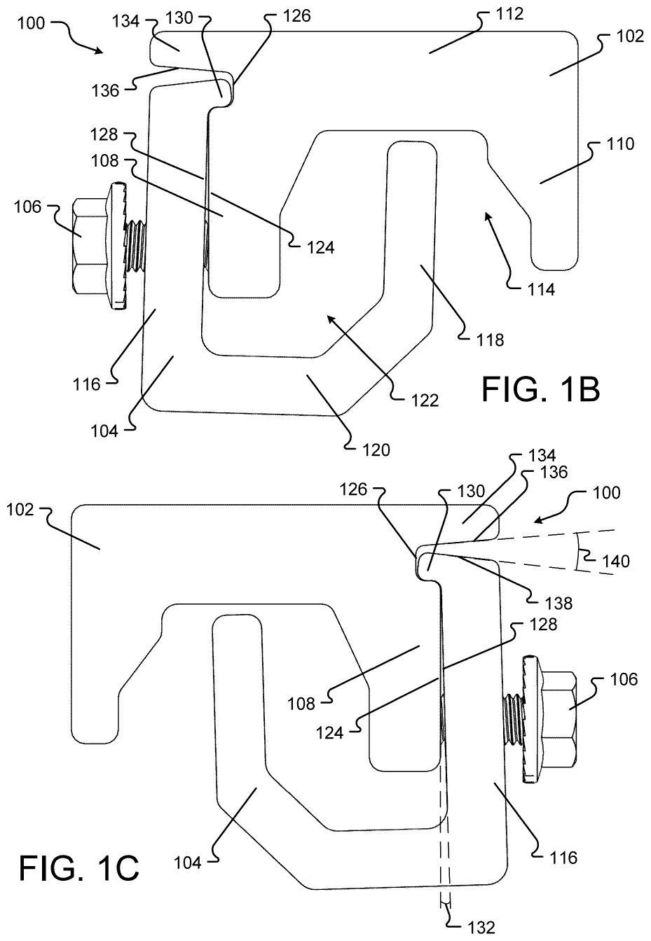

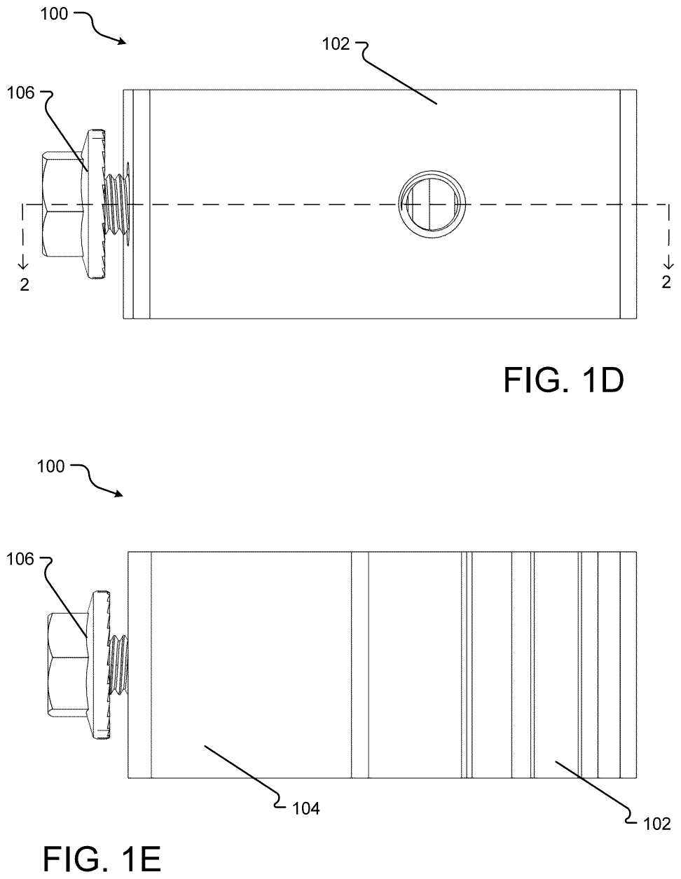

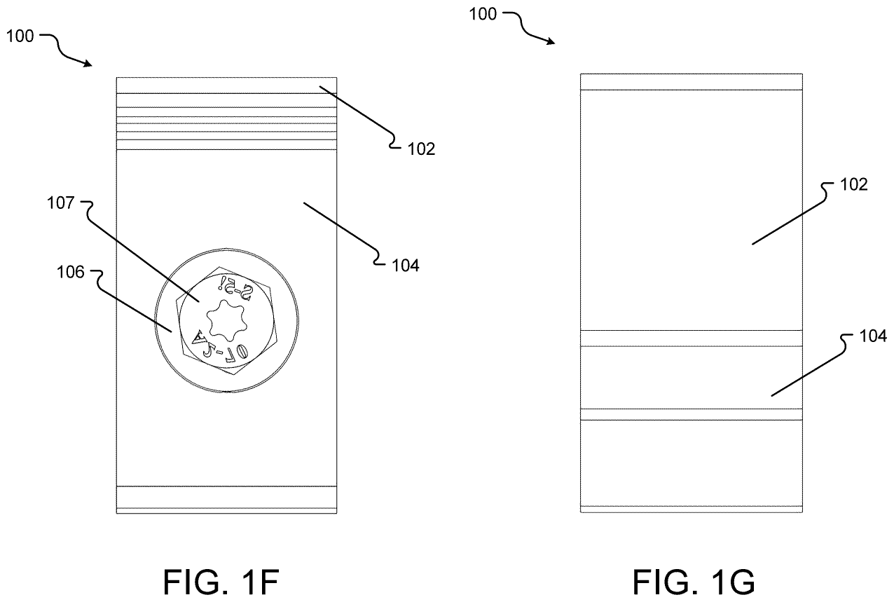

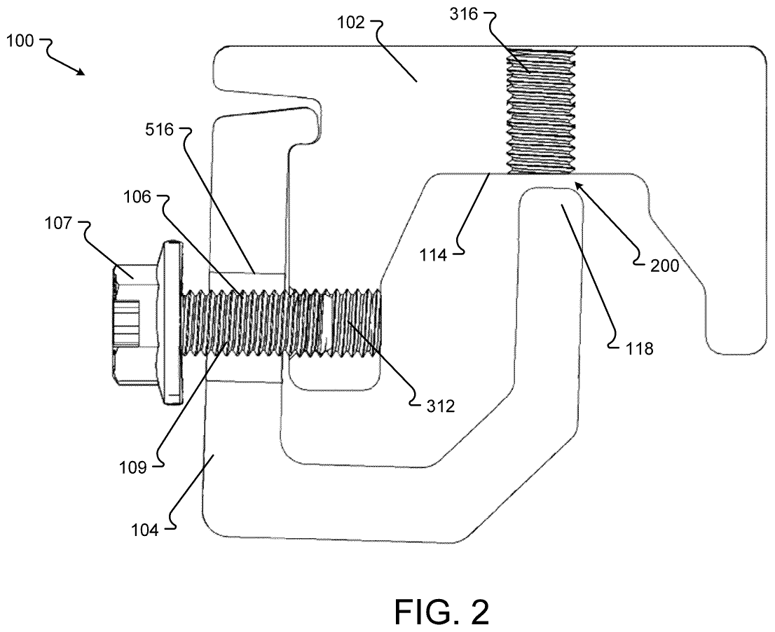

FIGS. 1A-1G and 2 in general illustrate a mounting device 100, in accordance with one or more embodiments of the present disclosure. It is noted that FIG. 2 is a cross-section of the mounting device 100, as noted by the section line 2-2 in FIG. 1D.

The mounting device 100 includes a body 102 and an insert 104. Optionally, the body 102 and the insert 104 are coupled together via a fastener 106. For example, the fastener 106 is insertable into the body 102 and/or the insert 104. The fastener 106 may directly engage with one or more of the body 102 and the insert 104 (i.e., via complementary threading between the fastener 106 and the body 102 and/or the insert 104) to secure the body 102 to the insert 104. By way of another example, the fastener 106 may be configured to engage with a second fastener (i.e., a nut, cotter pin, or the like), such that the fastener 106 only indirectly engages with one or more of the body 102 and the insert 104.

The fastener 106 may include one or more types of tool connections. For example, the fastener 106 may include an internal tool connection, including a slot connection, cross or Philips connection, a hex or Allen connection, a star or Torx connection, a tool connection with a security feature, or other internal surface or cavity within an exterior face of the head 107 of the fastener 106 able to receive a tool. By way of another example, the fastener 106 may include an external tool connection including one or more exterior surfaces able to receive a tool including a wrench, socket, or other tool able to at least partially surround and engage the one or more exterior surfaces on a head 107 of the fastener 106.

In embodiments, the body 102 includes a first arm 108, a second arm 110, and a wall 112 therebetween that at least partially define a cavity or throat 114. It should be understood that, depending on the configuration of the first arm 108 and/or the second arm 110, the wall 112 may be considered a portion of the first arm 108 and/or the second arm 110, without departing from the scope of the present disclosure.

In embodiments, the insert 104 includes a first leg 116, a second leg or trunk 118, and a wall 120 therebetween that at least partially define a cavity 122. It should be understood that, depending on the configuration of the first leg 116 and/or the trunk 118, the wall 120 may be considered a portion of the first leg 116 and/or the trunk 118, without departing from the scope of the present disclosure.

In embodiments and when the mounting device 100 is in use, the first arm 108 of the body 102 is at least partially inserted into the cavity 122 defined by the insert 104, (i.e., when the mounting device 100 is assembled). A side surface 124 of the first arm 108 includes a notch 126. A side surface 128 on an interior of the first leg 116 includes a protrusion 130 that extends inward from the first leg 116. The protrusion 130 is insertable into the notch 126 during assembly of the mounting device 100.

In some embodiments, the notch 126 and the protrusion 130 are complementary and non-interfering. For example, the notch 126 and the protrusion 130 may each have a cross-section where the protrusion 130 may be inserted/removed in a lateral direction (i.e., away from) or in a longitudinal direction (i.e., slid into the notch 126 from a front or rear surface of the body 102) relative to the notch 126. For instance, the notch 126 and the protrusion 130 may each include complementary portions of a triangular, quadrilateral, or up to an N-sided polygon (where N is any positive discrete integer).

In other embodiments, the notch 126 and the protrusion 130 may have complementary and interfering cross-sections. For example, the protrusion 130 may be inserted/removed in a longitudinal direction (i.e., slid into the notch 126 from a front or rear surface of the body 102) relative to the notch 126. For instance, one of the notch 126 and the protrusion 130 may have a circular cross-section, and the other of the notch 126 and the protrusion 130 may have a cavity that is operable to receive the circular cross-section (e.g., with an interior surface contoured to conform to an arc that is less than, approximately equal to, or greater than 180° of the circular cross-section). By way of another example, the protrusion 130 may be inserted/removed in a lateral direction (i.e., away from) relative to the notch 126 via a snapping or other engaging motion that causes temporary and elastic deformation of the notch 126 and/or the protrusion 130 during insertion and/or removal.

In further embodiments, the notch 126 and the protrusion 130 may have complementary cross-sections that are complex shapes. For example, the complex shapes may include, but are not limited to, a dovetail shape, a shape having a middle (or distal) necked portion with a smaller width or diameter and a larger width or diameter at a proximal end portion, or the like.

In embodiments, the insert 104 is pivotable with respect to the body 102 via the engaged protrusion 130 and the notch 126 when the protrusion 130 is fully seated within the notch 126. To assist in the pivoting or rotating motion, the side surface 124 of the first arm 108 and the side surface 128 of the first leg 116 are optionally set at an angle 132 that is oblique (i.e., a substantially non-zero angle that may be greater than approximately 90 degrees or less than approximately 90 degrees) to one another. It is noted, however, that the side surface 124 and the side surface 128 may be substantially parallel (or the angle 132 has a magnitude of substantially zero) when the protrusion 130 is first inserted into the notch 126, without departing from the present disclosure.

In one non-limiting example, the magnitude of the angle 132 (e.g., as illustrated in FIG. 1C) may decrease during installation, from a first magnitude in a first configuration or orientation of the mounting device 100 when the protrusion 130 is inserted into the notch 126 to a second magnitude in a second configuration or orientation of the mounting device when the body 102 and the insert 104 are coupled to a panel projection, with the second magnitude being less than the first magnitude. In some instances, fully coupling the body 102 to the insert 104 causes the side surface 124 and the side surface 128 to come into contact, such that the side surface 124 and the side surface 128 are substantially parallel (or the angle 132 has a magnitude of substantially zero for the second configuration).

In embodiments, engaging the insert 104 (i.e., a surface 506, as described in detail further herein) with the head 107 of the fastener 106 when the protrusion 130 is fully seated within the notch 126 causes a pivoting or rotating motion of the insert 104 with respect to the body 102. For example, the pivoting or rotating motion may occur when the fastener 106 is tightened (i.e., in a first direction of rotation) against the insert 104 and/or may occur when the fastener 106 is loosened (i.e., in a second direction of rotation) with respect to the insert 104. It is noted that where the protrusion 130 is not initially fully seated within the notch 126, that engaging the insert 104 (i.e., a surface 506, as described in detail further herein) with the fastener 106 may cause the protrusion 130 to fully seat within the notch 126 either prior to during the pivoting or rotating of the insert 104 with respect to the body 102.

Optionally, the body 102 includes a tab 134. For example, the tab 134 may extend outward from (or be an integral component of) the wall 112. A surface 136 of the tab 134 may at least partially define the notch 126 that is inset within the side surface 124 of the first arm 108. To assist in the pivoting or rotating motion, the surface 136 of the tab 134 and a surface 138 of the protrusion 130 are optionally set at an angle 140 that is oblique (i.e., a substantially non-zero angle that may be greater than approximately 90 degrees or less than approximately 90 degrees) to one another. It is noted, however, that the surface 136 and the surface 138 may be substantially parallel (or the angle 140 may have a magnitude that is substantially 0° or) 180° when the protrusion 130 is first inserted into the notch 126, without departing from the present disclosure.

In one non-limiting example, the angle 140 (e.g., as illustrated in FIG. 1C) may increase during installation, from a first magnitude in the first configuration or orientation of the mounting device 100 when the protrusion 130 is inserted into the notch 126 to a second magnitude in the second configuration or orientation of the mounting device 100 when the body 102 and the insert 104 are fully secured to a panel projection, with the first magnitude being less than the second magnitude.

Referring now to FIG. 2, the throat 114 of the body 102 and the trunk 118 define a gap 200. In some embodiments, engaging the body 102 and the insert 104 with the fastener 106 may cause the gap 200 to increase or decrease in magnitude (or height) (i.e., via pivoting or rotating of the insert 104 relative to the body 102 about an axis proximate to the coupling of the notch 126 and the protrusion 130). In general, a minimum magnitude of the gap 200 may be equal to or less than two times a thickness of material of the panel projection where the panel projection includes two layers, or more generally may be equal to or less than N times a thickness of material of the panel projection where the panel projection includes an N number of layers (and where N is any positive discrete integer). Notably, when the protrusion 130 is positioned within the notch 126 as generally illustrated in FIG. 2, the insert 104 may not rotate around an axis of the fastener 106 relative to the body 102. Accordingly, the engagement of the protrusion 130 in the notch 126 beneficially prevents disengagement or separation of the insert from the body.

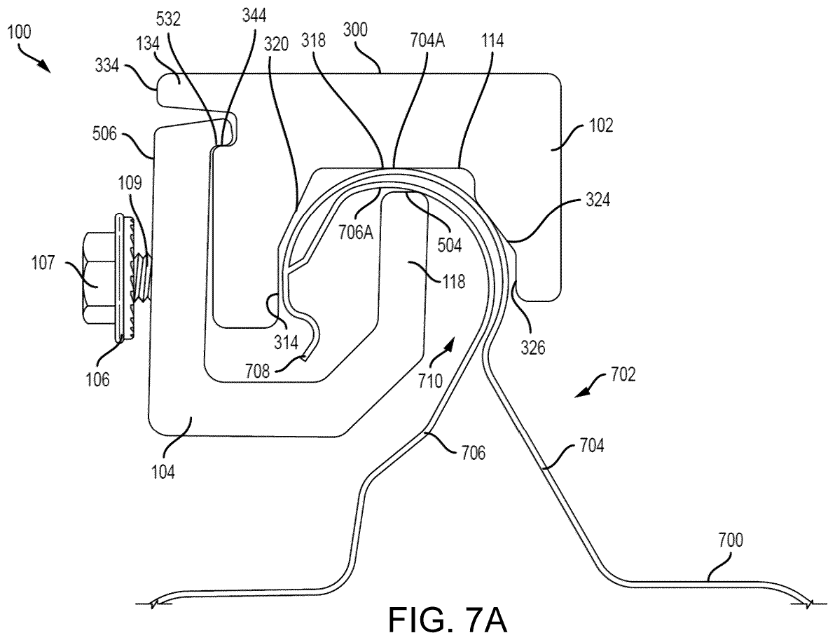

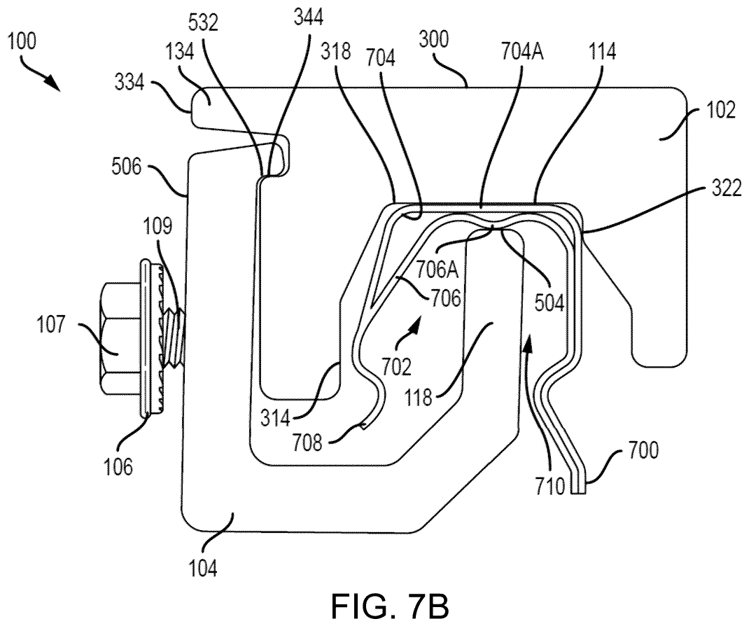

In some embodiments, the gap 200 retains at least some distance or height between the throat 114 (e.g., a base surface 318 of the throat 114, as described in detail further herein) and the trunk 118 (e.g., a surface 504 of the trunk 118, as described in detail further herein) when the fastener 106 is fully tightened within the body 102 and the insert 104. It is noted that the gap 200 having some distance remaining when the fastener 106 is fully tightened may prevent excess force beyond the necessary securing force to hold the mounting device 100 to a panel projection (i.e., 702, as illustrated in FIGS. 7A-7B) being applied by the panel projection 702 on the mounting device 100, which may reduce the possibility of damage to or breakage of the mounting device 100 during or after installation.

In other embodiments, the gap 200 is fully closed when the fastener 106 is fully tightened within the body 102 and the insert 104, such that the trunk 118 makes contact with the throat 114. It is noted that the gap 200 being able to completely close may assist in the securing of the mounting device to the panel projection 702, as the panel projection 702 would apply a counter force that prevents the gap 200 from fully closing. The counter force may be a binding force or a similar force that transfers to the fastener 106 and the body 102 via the insert 104, preventing accidental backout of the fastener 106 from the body 102.

As illustrated in FIG. 2 and as described in detail further herein, the body 102 may include an aperture 316 and/or an aperture 312. In addition, and as described in detail further herein, the insert 104 may include an aperture 516. In some embodiments, the fastener 106 may be insertable into the aperture 312 and the aperture 516.

Reference will be made to each of the body 102 and the insert 104 in detail further herein. In addition, any, and/or all of the body 102 and the insert 104 may include further components or subassemblies as described in detail further herein, which are each considered components or subassemblies of the mounting device 100.

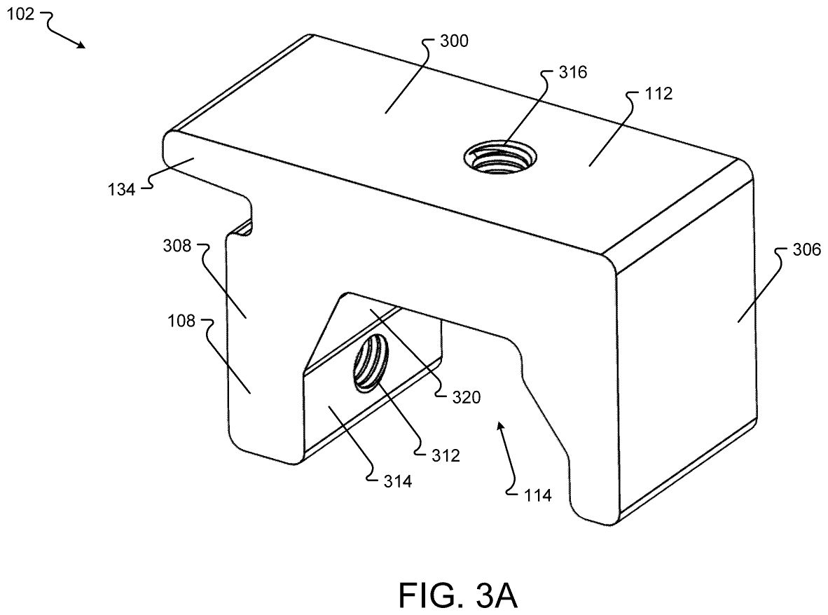

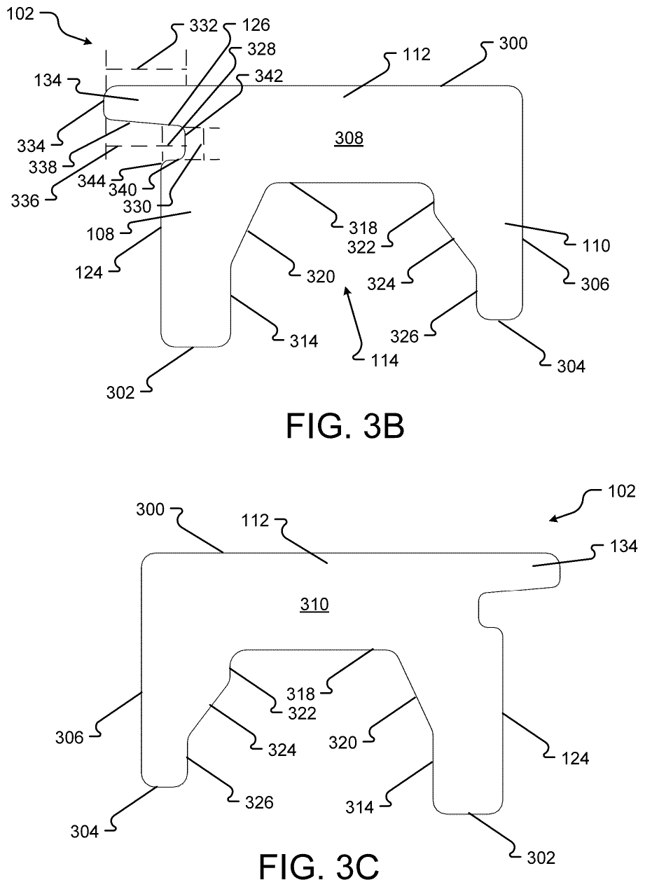

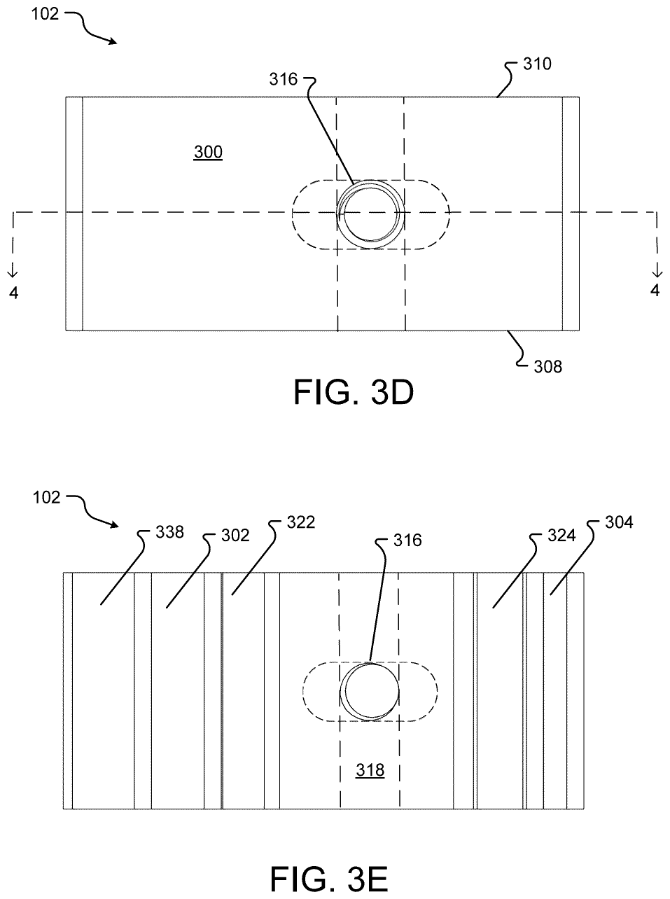

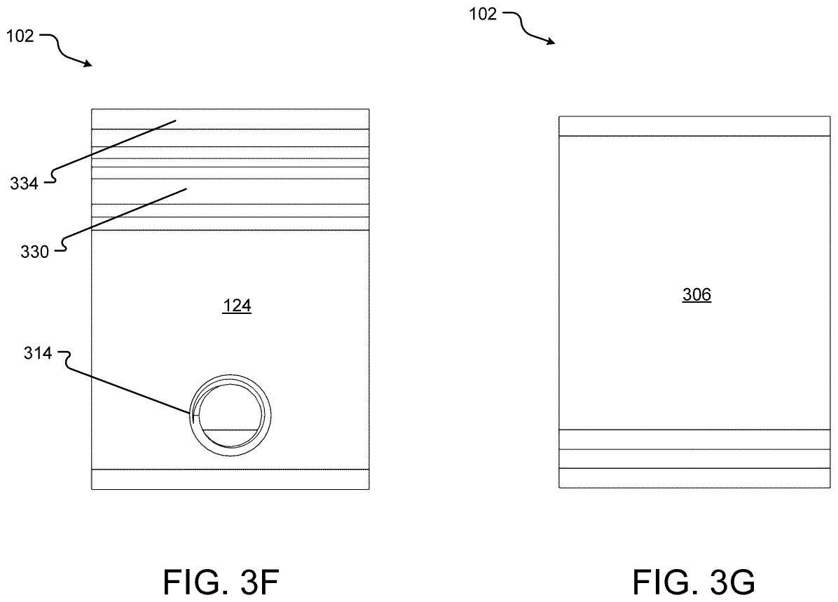

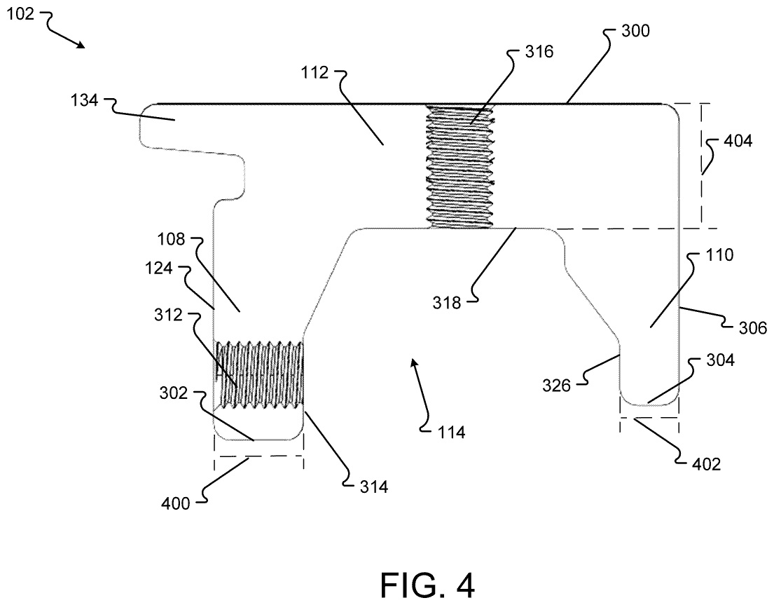

FIGS. 3A-3G and 4 in general illustrate the body 102 of the mounting device 100, in accordance with one or more embodiments of the present disclosure. It is noted that FIG. 4 is a cross-section of the body 102, as noted by the section line 4-4 in FIG. 3D. Any embodiments directed to the body 102 in FIGS. 3A-3G and 4 should be understood as being directed to the body 102 in FIGS. 1A-1G and 2, and vice versa, without departing from the scope of the present disclosure.

In embodiments, the body 102 includes an upper surface 300 opposite a first lower surface 302 and a second lower surface 304, a side surface 306 opposite the side surface 124, and a front surface 308 opposite a rear surface 310. In some non-limiting examples, the body 102 may be manufactured via an extrusion process in a direction from the front surface 308 to the rear surface 310 (or vice versa).

In some embodiments, one or more adjacent sets (i.e., that share an edge or vertex) of the upper surface 300, the first lower surface 302, the second lower surface 304, the side surface 306, the side surface 124, the front surface 308, and/or the rear surface 310 are substantially perpendicular to one another (e.g., set at an angle that is approximately) 90°. In other embodiments, one or more adjacent sets (i.e., that share an edge or vertex) of the upper surface 300, the first lower surface 302, the second lower surface 304, the side surface 306, the side surface 124, the front surface 308, and/or the rear surface 310 are set at an oblique angle to one another (e.g., a substantially non-zero angle that may be greater than approximately 90 degrees or less than approximately 90 degrees).

In some embodiments, one or more opposite sets (i.e., that do not share an edge or vertex) of the upper surface 300, the first lower surface 302, the second lower surface 304, the side surface 306, the side surface 124, the front surface 308, and/or the rear surface 310 are substantially parallel to one another (i.e., set at an angle that is substantially 0° or 180°).

In some embodiments, one or more of the upper surface 300, the first lower surface 302, the second lower surface 304, the side surface 306, the side surface 124, the front surface 308, and/or the rear surface 310 is substantially flat or planar, to allow the body 102 to rest on the respective surface while one or more post-extrusion processes are performed while reducing any bottlenecking during the manufacturing process of the body 102 that may occur with the one or more post-extrusion processes. For example, the post-extrusion processes may include, but are not limited to, forming (e.g., drilling, punching, or the like) an aperture 312 within the first arm 108 (e.g., through the side surface 124 of the first arm 108 and/or through a side surface 314 that is interior of the first arm 108), forming (e.g., drilling, punching, or the like) an aperture 316 within the wall 112 (e.g., through the upper surface 300 of the wall 112 and/or through a base surface 318 that is interior of the wall 112), assembly of the mounting device 100 including insertion of the fastener 106 into the insert 104 and the body 102, or the like.

In some non-limiting examples, the aperture 312 is used to couple the insert 104 to the body 102 via the fastener 106 (illustrated in FIGS. 1A-1G and 2). For instance, the aperture 312 may be located within the first arm 108 of the body 102. The aperture 312 may be within the side surface 124 of the first arm 108. The aperture 312 may extend a select depth into the first arm 108 including, optionally, entirely through the first arm 108 and through the side surface 314 that partially defines the throat 114.

In embodiments, the throat 114 is defined by one or more interior surfaces of the body 102. For example, the one or more interior surfaces of the body 102 that define the throat 114 may include, but are not limited to, the side surface 314, the base surface 318, a side surface 320, a side surface 322, a side surface 324, and a side surface 326. However, the number and dimensions of the one or more interior surfaces defining the throat 114 may be dependent on the configuration of a panel projection, as at least some of the one or more interior surfaces defining the throat 114 are contoured to engage or otherwise conform to the panel projection.

It is noted that the throat 114 is not limited to being defined by the interior surfaces 314, 318, 320, 322, 324, 326, however, and that more or fewer interior surfaces of the body 102 may define the throat 114, without departing from the scope of the present disclosure. In addition, it is noted that one or more of the surfaces 314, 318, 320, 322, 324, 326 may be considered portions of the same surface, without departing from the scope of the present disclosure.

In some non-limiting examples, the upper surface 300 and the base surface 318 are substantially parallel to one another (i.e., set at an angle that is substantially 0° or) 180°.

In other non-limiting examples, the first bottom surface 302 and the side surface 314, the second bottom surface 304 and the side surface 306, and/or the base surface 318 and the side surface 322 are substantially perpendicular to one another (i.e., set at an angle that is approximately) 90°.

In other non-limiting examples, the side surface 320 is sloped (i.e., set at a non-zero or oblique angle that is between 0° and 90°, or between 90° and) 180° from the side surface 314 and/or the base surface 318.

In other non-limiting examples, the side surface 324 is sloped (i.e., set at a non-zero or oblique angle that is between 0° and 90°, or between 90° and 180°) from the side surface 322 and/or the side surface 326.

It should be understood, however, that the above example angles between surfaces of the body 102 are merely illustrative and should not be interpreted as limiting on the present disclosure. In addition, it should be understood that the angles are non-limiting examples of a body 102 that is configured based on the specific panel projections illustrated in FIGS. 7A and 7B, as described in detail further herein.

In embodiments, the notch 126 is inset within the side surface 124 a depth 328, and has a height 330. In some embodiments, the tab 134 of the body 102 extends outward from the wall 112 a length 332 that is greater than the depth 328, such that the tab 134 has a side surface 334 that is spaced from the side surface 124 by a width 336, and a lower surface 338 that has a dimension that corresponds to the combination of the width 336 and the depth 328. In some embodiment, the notch 126 extends from the front surface 308 to the rear surface 310. Optionally, the shape of a cross-section of the notch 126 does not change between the front surface 308 and the rear surface 310.

In embodiments, the notch 126 has an upper surface 340 opposite the lower surface 338 of the tab 134, and an insert surface 342 therebetween. In some instances, the lower surface 338 and the upper surface 340 are set at an oblique angle to one another (i.e., a substantially non-zero angle that may be greater than approximately 90 degrees or less than approximately 90 degrees).

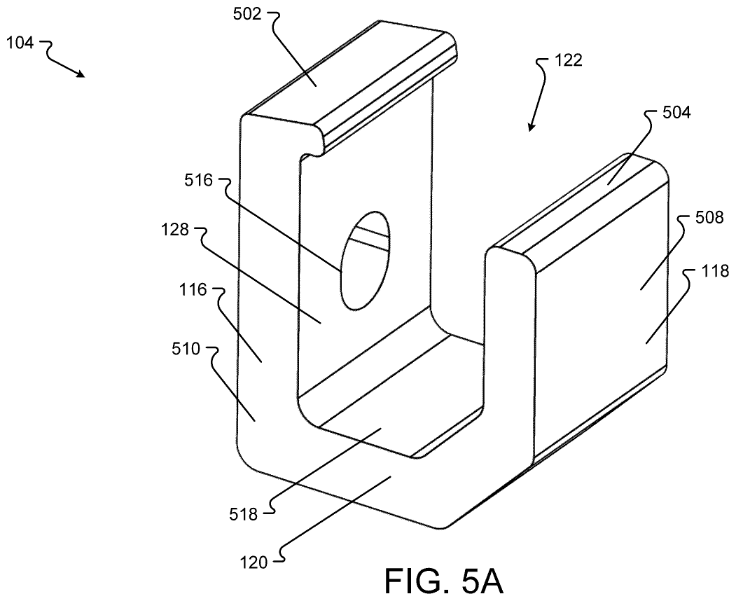

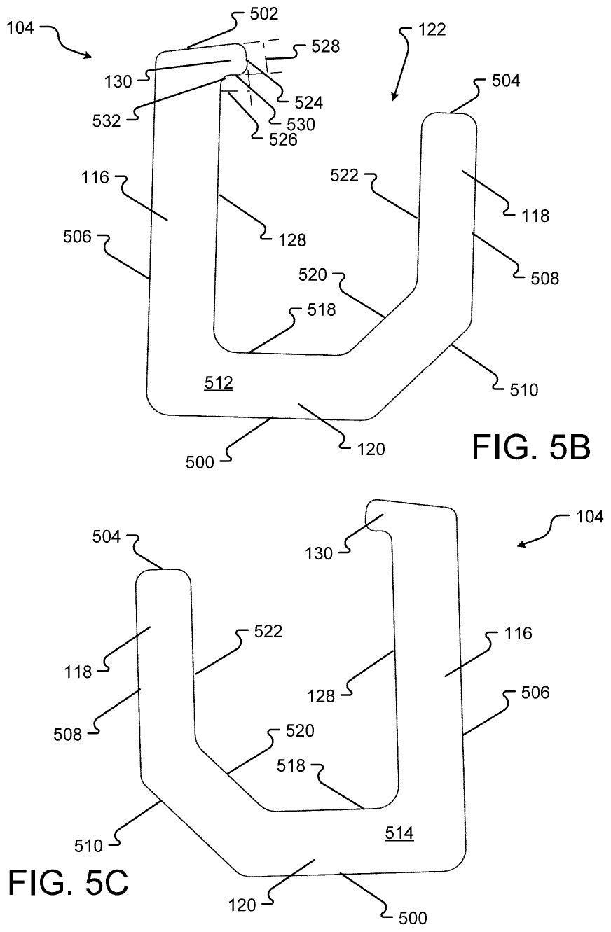

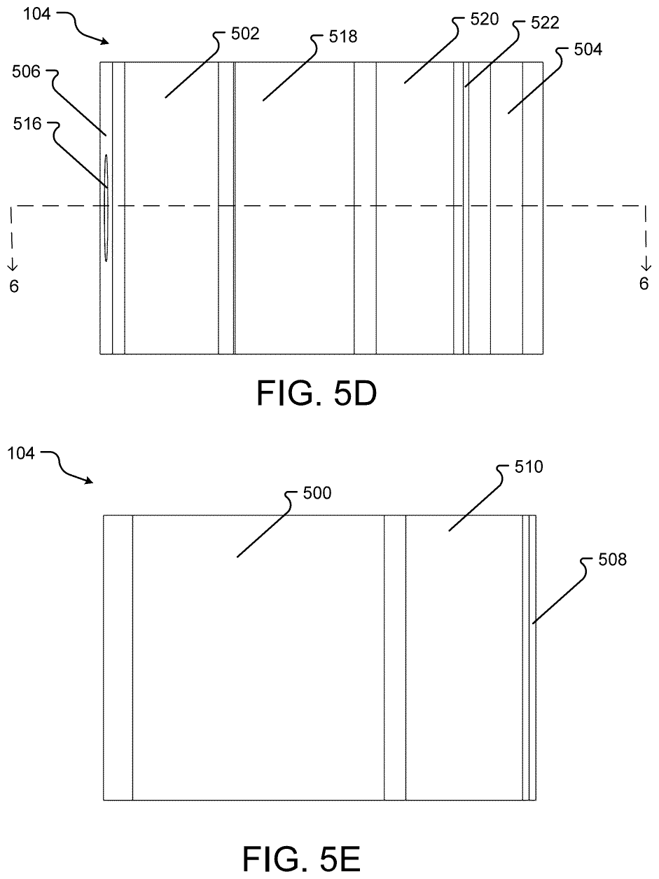

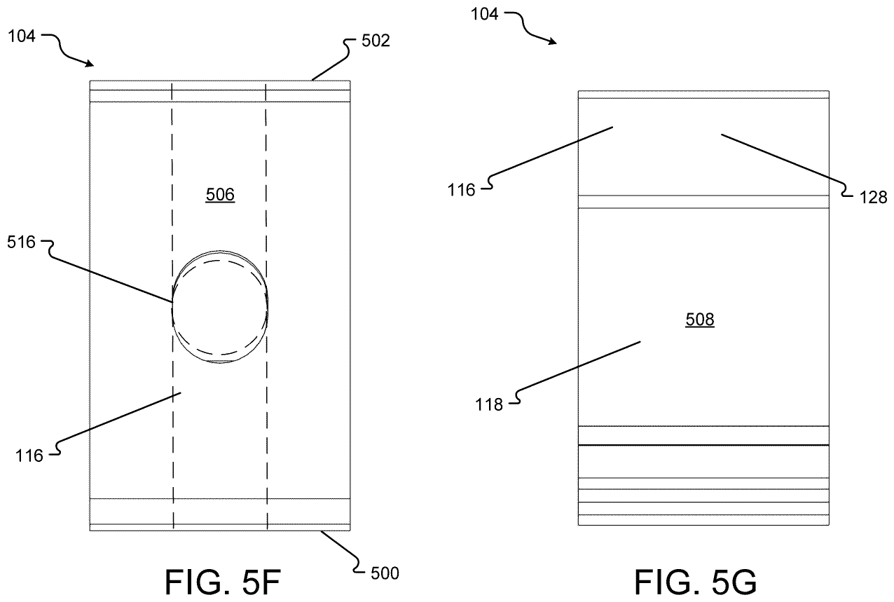

In embodiments, the notch 126 has a pivot corner 344 between the upper surface 340 and the side surface 124. In some configurations, the pivot corner 344 is configured to engage with a pivot corner 532 of the insert 104 (e.g., as illustrated in FIG. 5B) when the insert 104 pivots or rotates relative to the body 102. It is noted that the axis about which the insert 104 pivots or rotates relative to the body 102 may be proximate to the interface between the pivot corner 344 of the body 102 and the pivot corner 532 of the insert 104, including optionally through the pivot corner 344 of the body 102, without departing from the scope of the present disclosure.

It should be understood, however, that the dimensions of the tab 134 are merely illustrative, and should not be interpreted as limiting on the present disclosure. In addition, it should be understood that the tab 134 itself may be optional. However, it is contemplated that an upper surface of the tab 134 may provide an added benefit of increased surface area for a component to rest on when attached to the mounting device 100 via the aperture 316, in addition to the upper surface 300. In addition, it is contemplated that the tab 134 may provide an added benefit of increasing the dimensions of the notch 126 (i.e., to have at least a third defined surface), as compared to if the notch 126 extended all the way to the upper surface 300. Further, it is contemplated that the tab 134 and the upper surface 338 may provide a stop to limit rotation of the insert 104 relative to the body 102.

Referring now to FIG. 4, in embodiments the first arm 108 has a first width 400 for the first bottom surface 302 (or first thickness between the side surface 124 and the side surface 314). The second arm 110 has a second width 402 for the second bottom surface 304 (or second thickness between the side surface 306 and the side surface 326). Optionally, the second width 402 is different from the first width 400. In some non-limiting examples, the first width 400 is greater than the second width 402. It should be understood that the widths 400, 402 illustrated in FIGS. 3A-3G and 4 are merely illustrative, and are not intended on being limiting for purposes of the present disclosure. In general, the first width 400 may be any width (or thickness between the side surfaces 124, 314) to allow for a threaded fastener 106 to sufficiently engage with the body 102 when inserted into aperture 312, where the aperture 312 has complementary threading. For instance, the first width 400 may allow for at least two, three, four, five, or more full revolutions of the fastener 106 within the aperture 312 for sufficient engagement.

In some embodiments, the aperture 316 may be used for attaching additional auxiliary structures or components (i.e., heating units, air conditioning units, ventilation equipment, solar panels or other photovoltaic equipment, snow retention systems, and the like) to the panel projection via the mounting device 100. For instance, the aperture 316 may be located within the wall 112 of the body 102. The aperture 316 may extend through the upper surface 300 of the wall 112. The aperture 316 may extend a select depth into the wall 112 including, optionally, entirely through the wall 112 and through the base surface 318 that partially defines the throat 114.

Although the aperture 316 is illustrated as being substantially circular in diameter, it should be understood that is merely illustrative and should not be interpreted as limiting on the present disclosure. For example, as illustrated in FIGS. 3D and 3E, the aperture 316 may be smooth-walled and in the form of an elongated slot, in a direction defined by the width of the body 102 or in a direction defined by a direction of extrusion for the body 102. By way of another example, the aperture 316 may be smooth-walled and extend to opposite surfaces (e.g., 308/310, or the like), in a direction defined by a direction of extrusion for the body 102 or in a direction defined by the width of the body 102.

In embodiments, the wall 112 has a height 404 between the upper surface 300 and the base surface 318. It should be understood that the height 404 illustrated in FIGS. 3A-3G and 4 is merely illustrative and is not intended on being limiting for purposes of the present disclosure. In general, the height 404 may be any height between the upper surface 300 and the base surface 318 to allow for a threaded fastener with a thread pitch to sufficiently engage with the aperture 316 when inserted therein, in instances where the aperture 316 has complementary threading with the thread pitch. In some embodiments, the aperture 316 has a length at least two times greater than the thread pitch of exterior threading of a threaded fastener insertable in the aperture 316 to ensure sufficient engagement. Additionally, the height 404 is selected to ensure the aperture 316 has a sufficient length to prevent an end of the threaded fastener from extending into the throat 114 to prevent or reduce damage to a panel projection position in the throat 114. Optionally, the height 404 is different from the second width 402 and/or the first width 400. In some embodiments, the height 404 is greater than the first width 400. Additionally, or alternatively, the height 404 is optionally greater than the second width 402.

In at least one embodiment, aperture 312 and aperture 316 are the only apertures or holes of the body 102. More specifically, in embodiments, there are no apertures or holes that extend at least partially into or completely through the second arm 110 of the body. Forming the body 102 with only two apertures (namely, aperture 312 and aperture 316) beneficially decreases the number of operations, time, and costs necessary to produce the body 102 according to embodiments of the present disclosure. However, it is contemplated that the body 102 may include additional apertures, without departing from the scope of the present disclosure.

In general, with respect to FIGS. 3A-3G and 4, it should be understood that at least the surfaces 124, 300, 302, 304, 306, 308, 310, 334, 338, 340, and 342 may be considered “exterior surfaces” of the body 102, for purposes of the present disclosure. In addition, it should be understood that at least the surfaces 314, 318, 320, 322, 324, and 326 may be considered “interior surfaces” of the body 102, for purposes of the present disclosure.

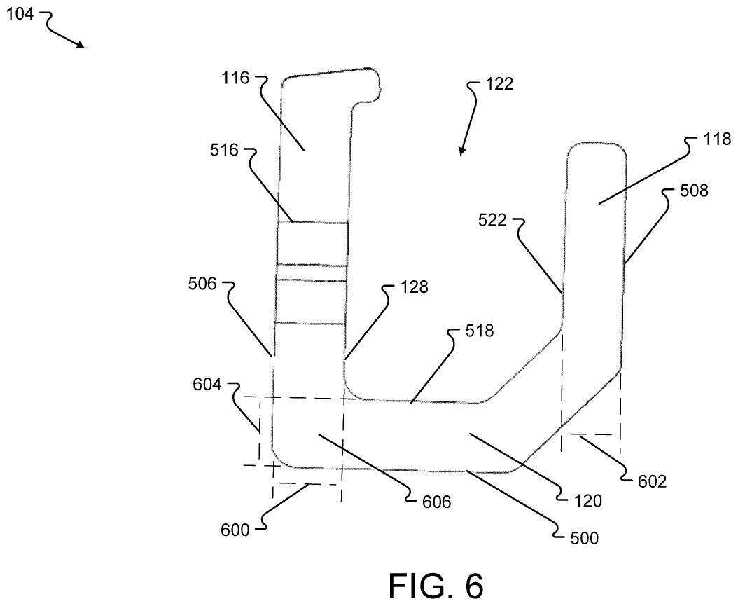

FIGS. 5A-5G and 6 in general illustrate the insert 104 of the mounting device 100, in accordance with one or more embodiments of the present disclosure. It is noted that FIG. 6 is a cross-section of the mounting device 100, as noted by the section line 6-6 in FIG. 5D. Any embodiments directed to the insert 104 in FIGS. 5A-5G and 6 should be understood as being directed to the insert 104 in FIGS. 1A-1G and 2, and vice versa, without departing from the scope of the present disclosure.

In embodiments, the insert 104 includes a lower surface 500 opposite an upper surface 502 and an upper surface 504, a side surface 506 opposite a side surface 508, a side surface 510, and a front surface 512 opposite a rear surface 514. It is noted that the upper surface 504 may be considered to be a proximal end, or be located at a proximal end of, the trunk 118. In some non-limiting examples, the insert 104 may be manufactured via an extrusion process in a direction from the front surface 512 to the rear surface 514 (or vice versa).

In some embodiments, one or more adjacent sets (i.e., that share an edge or vertex) of the lower surface 500, the upper surface 502, the upper surface 504, the side surface 506, the side surface 508, the side surface 510, the front surface 512, and/or the rear surface 514 are substantially perpendicular to one another (i.e., set at an angle that is approximately) 90°. In other embodiments, one or more adjacent sets (i.e., that share an edge or vertex) of the lower surface 500, the upper surface 502, the upper surface 504, the side surface 506, the side surface 508, the side surface 510, the front surface 512, and/or the rear surface 514 are set at an oblique angle to one another (i.e., a substantially non-zero angle that may be greater than approximately 90 degrees or less than approximately 90 degrees).

In some embodiments, one or more opposite sets (i.e., that do not share an edge or vertex) of the lower surface 500, the upper surface 502, the upper surface 504, the side surface 506, the side surface 508, the side surface 510, the front surface 512, and/or the rear surface 514 are substantially parallel to one another (i.e., set at an angle that is substantially 0° or) 180°.

In some embodiments, one or more of the lower surface 500, the upper surface 502, the upper surface 504, the side surface 506, the side surface 508, the side surface 510, the front surface 512, and/or the rear surface 514 is substantially flat or planar, to allow the insert 104 to rest on the respective surface while one or more post-extrusion processes are performed while reducing any bottlenecking during the manufacturing process of the insert 104 that may occur with the one or more post-extrusion processes. For example, the post-extrusion processes may include, but are not limited to, forming (e.g., drilling, punching, or the like) an aperture 516 within the first leg 116 (e.g., through the side surface 506 of the first leg 116 and/or through the side surface 128 that is interior of the first leg 116), or the like.

In some non-limiting examples, the aperture 516 is used to couple the insert 104 to the body 102 via the fastener 106 (as illustrated in FIGS. 1A-1G and 2). For instance, the aperture 516 may be located within the first leg 116 of the insert 104. The aperture 516 may be within the side surface 506 of the first leg 116. The aperture 516 may extend a select depth into the first leg 116 including, optionally, entirely through the first leg 116 and through the side surface 128 that partially defines the cavity 122.

The aperture 516 may be smooth-bore and have a slot configuration. The slot configuration for the aperture 516 allows for the fastener 106 to move within the insert 104 during installation. For example, passing the fastener 106 through the aperture 516 and into the aperture 312 of the body 102 (i.e., as illustrated in FIGS. 3A-3G and 4) causes a head 107 of the fastener 106 to press against the side surface 506 when the fastener 106 is secured to the body 102 (e.g., by complementary threading on the aperture 312 and the fastener 106, or via a nut or cotter pin that couples to the fastener 106 once the fastener 106 passes through the aperture 312, etc.) As a shaft 109 of the fastener 106 is rotated further to secure the fastener 106 to the body 102, the head 107 continues to press and against the insert 104 and causes the insert 104 to pivot or rotate relative to the body 102 via the corresponding notch 126 and the protrusion 130. With the slot configuration for the aperture 516, the fastener 106 is able to move within the aperture 516 during the tightening to promote the pivoting or rotating motion between the corresponding notch 126 and the protrusion 130.

Although the aperture 516 is illustrated as having a slot configuration, it should be understood that is merely illustrative and should not be interpreted as limiting on the present disclosure. For example, as illustrated in FIG. 5F, the aperture 516 may be substantially circular in diameter. By way of another example, the aperture 516 may extend to opposite surfaces (e.g., 500/502, or the like), in a direction defined by the height of the insert 104 or in a direction defined by a direction of extrusion for the insert 104.

In at least one embodiment, aperture 516 is the only aperture or hole of the insert 104. More specifically, in embodiments, there are no apertures or holes that extend at least partially into or completely through the wall 120 of the insert 104. Additionally, or alternatively, in some embodiments, there are no apertures or holes that extend at least partially into or completely through the trunk 118 of the insert 104. Forming the insert 104 with only one aperture (namely, aperture 516) beneficially decreases the number of operations, time, and costs necessary to produce the insert 104 according to embodiments of the present disclosure. However, it is contemplated that the insert 104 may include additional apertures, without departing from the scope of the present disclosure.

In embodiments, the cavity 122 is defined by one or more interior surfaces of the insert 104. For example, the one or more interior surfaces of the insert 104 may include, but are not limited to, the side surface 128, a base surface 518, a side surface 520, and a side surface 522. However, the number and dimensions of the one or more interior surfaces defining the cavity 122 may be dependent on the configuration of a panel projection, such that at least some of the one or more interior surfaces defining the cavity 122 are contoured to conform to exterior surfaces of the insert 104 that engage or otherwise conform to the panel projection.

It is noted that the cavity 122 is not limited to being defined by the interior surfaces 128, 518, 520, 522, however, and that more or fewer interior surfaces of the insert 104 may define the cavity 122, without departing from the scope of the present disclosure. In addition, it is noted that one or more of the surfaces 128, 518, 520, 522 may be considered portions of the same surface, without departing from the scope of the present disclosure.

In some non-limiting examples, the lower surface 500 and the base surface 518, the side surface 128 and the side surface 506, the side surface 510 and the side surface 520, and/or the side surface 508 and the side surface 522 are substantially parallel to one another (i.e., set at an angle that is substantially 0° or) 180°.

In other non-limiting examples, the upper surface 502 and the side surface 506, and/or a side surface 524 of the protrusion 130 and the side surface 128, are set at an oblique angle to one another (i.e., a substantially non-zero angle).

In other non-limiting examples, the upper surface 504 is substantially perpendicular (i.e., set at an angle that is approximately) 90° to the side surface 508 and/or the side surface 522.

In other non-limiting examples, the side surface 510 is sloped (i.e., set at a non-zero or oblique angle that is between 0° and 90°, or between 90° and) 180° from the lower surface 500 and/or the side surface 508.

In other non-limiting examples, the side surface 520 is sloped (i.e., set at a non-zero or oblique angle that is between 0° and 90°, or between 90° and 180°) from the base surface 518 and/or the side surface 522.

It is noted herein that the side surface 510 (e.g., with corresponding side surface 520) is sloped to increase clearance for the insertion of the trunk 118 within a cavity defined in a panel projection, as described in further detail with respect to FIGS. 7A-7B.

It should be understood, however, that the above example angles between surfaces of the insert 104 are merely illustrative and should not be interpreted as limiting on the present disclosure. In addition, it should be understood that the angles are non-limiting examples of an insert 104 configured based on the specific panel projections illustrated in FIGS. 7A and 7B, as described in detail further herein.

In embodiments, the protrusion 130 extends from the side surface 128 a distance or length 526, and has a height 528. For example, the length 526 of the protrusion 130 may be approximately equal to the depth 328 of the notch 126, as illustrated in at least FIG. 3B. By way of another example, the height 528 of the protrusion 130 may be less than a height 330 of the notch 126.

In embodiments, the protrusion 130 has a lower surface 530 opposite the upper surface 502, and the side surface 524 therebetween. In some instances, the lower surface 530 and the upper surface 502 are set at an oblique angle to one another (i.e., a substantially non-zero angle that may be greater than approximately 90 degrees or less than approximately 90 degrees). In some embodiments, the protrusion 130 extends continuously from the front surface 512 to the rear surface 514. Optionally, the shape of a cross-section of the protrusion 130 does not change between the front surface 512 and the rear surface 514.

In embodiments, the protrusion 130 has a pivot corner 532 between the lower surface 530 and the side surface 128. In some configurations, the pivot corner 532 is configured to engage with the pivot corner 344 of the body 102 (e.g., as illustrated in FIG. 3B) when the insert 104 pivots or rotates relative to the body 102. It is noted that the axis about which the insert 104 pivots or rotates relative to the body 102 may be proximate to the interface between the pivot corner 344 of the body 102 and the pivot corner 532 of the insert 104, including optionally through the pivot corner 344 of the body 102, without departing from the scope of the present disclosure.

It is noted that the side surface 524 may at least partially make contact with, and/or may be spaced from, the inset surface 342 of the body 102 (e.g., as illustrated in FIG. 3B), without departing from the scope of the present disclosure. For example, the at least partially making contact with and/or being spaced from, may occur during the pivoting or rotating of the insert 104 relative to the body 102 about the axis proximate to the notch 126 of the body 102 and the protrusion 130 of the insert 104.

Referring now to FIG. 6, in embodiments the first leg 116 has a first width 600 (or first thickness between the side surface 506 and the side surface 128). The trunk 118 has a second width 602 (or second thickness between the side surface 508 and the side surface 522). Optionally, the first width 600 and the second width 602 are different. In some non-limiting examples, the first width 600 is greater than the second width 602. It should be understood that the widths 600, 602 illustrated in FIGS. 5A-5G and 6 are merely illustrative, and are not intended on being limiting for purposes of the present disclosure. In general, the first width 600 may be any width (or thickness between the side surfaces 506, 128) to allow a fastener 106 to pass through the aperture 516 and sufficiently engage with the insert 104 without causing the first leg 116 to deform when a force is applied on the first leg 116 by the head 107 of the fastener 106.

In embodiments, the wall 120 has a height 604 between the lower surface 500 and the base surface 518. In some non-limiting examples, the first width 600 of the first leg 116 and the height 604 of the wall 120 are substantially equal. In other non-limiting examples, the height 604 of the wall 120 may be less than the first width 600 of the first leg 116. Additionally, or alternatively, the second width 602 of the trunk 118 and the height 604 of the wall 120 are substantially equal in at least one embodiment. However, it should be understood that the height 604 illustrated in FIGS. 5A-5G and 6 is merely illustrative and is not intended on being limiting for purposes of the present disclosure.

In general, a corner 606 between the first leg 116 and the wall 120 is a sufficient thickness or radius to withstand and/or distribute forces applied by the engagement of the trunk 118 to the panel projection and/or the forces applied by the fastener 106 on the side surface 506.

In general, with respect to FIGS. 5A-5G and 6, it should be understood that at least the surfaces 500, 502, 504, 506, 508, 510, 512, 514, and 524 may be considered “exterior surfaces” of the insert 104, for purposes of the present disclosure. In addition, it should be understood that at least the surfaces 128, 518, 520, 522, and 530 may be considered “interior surfaces” of the insert 104, for purposes of the present disclosure.

FIGS. 7A and 7B illustrate environment views of the mounting device 100 with panel projections, in accordance with one or more embodiments of the present disclosure. Any embodiments directed to the mounting device 100 with body 102 and insert 104 illustrated in FIGS. 7A-7B should be understood as being directed to the mounting device 100, the body 102, and/or the insert 104 in FIGS. 1A-1G and 2, 3A-3G and 4, 5A-5G and 6, and vice versa, without departing from the scope of the present disclosure.

A metal panel 700 includes a panel projection 702. In some embodiments, the panel projection 702 includes an upper surface 704A of an upper section 704 and a lower surface 706A of a lower section 706. It should be understood that the upper surface 704A and/or the upper section 704 may be considered a “top geometry”, and the lower surface 706A and/or the lower section 706 may be considered a “bottom geometry”, of the panel projection 702, for purposes of the present disclosure.

The upper section 704 and the lower section 706 are overlaid and joined at a panel projection end 708. However, it is noted that the panel projection 702 may be manufactured from a single sheet of formed metal, where the upper section 704 is the upper surface 704A of the single sheet and the lower section 706 is the lower surface 706A of the single sheet, without departing from the scope of the present disclosure.

The body 102 is positioned on the upper section 704, such that one or more of the surfaces that define the throat 114 engage with the upper section 704. For example, as illustrated in FIG. 7A, the side surface 314, the side surface 320, the base surface 318, the side surface 324, and/or the side surface 326 may engage the upper section 704, where the panel projection 702 is a rounded or circular design. By way of another example, as illustrated in FIG. 7B, the side surface 322 and/or the base surface 318 may engage the upper section 704, where the panel projection 702 is an elongated or parallelogram (e.g., trapezoidal) design. It is noted that the securing of the mounting device 100 to the panel projection 702 via contact of surfaces that define the throat 114 of the body 102 in the above examples, and that the above examples are merely illustrative and are not to be interpreted as limiting.

The insert 104 is positioned such that the trunk 118 is within a projection cavity 710 of the panel projection 702. For example, the lower section 706 may be contoured to define the projection cavity 710, and the upper surface 504 (or proximal end) of the trunk 118 makes contact with the lower section 706 after the trunk 118 is inserted into the projection cavity 710.

Securing the fastener 106 within the body 102 and the insert 104 draws the throat 114 onto the upper section 704, and draws the upper surface 504 (or proximal end) of the trunk 118 into the lower section 706. The force applied by the body 102 to the upper section 704 by the body 102, and by the insert 104 to the lower section 706, causes the mounting device 100 to secure to the panel projection 702. It is noted that the force applied by the body 102 and the insert 104 may be sufficient to secure the mounting device 100 to the panel projection 702 without need for deformation on the panel projection 702. However, in some embodiments the panel projection 702 may be contoured with a surface designed to deform via contact by the body 102 and/or the insert 104, to ensure the mounting device 100 is secured to the panel projection 702 via a clamping action.

In some embodiments, as illustrated in at least FIGS. 7A and 7B, the side surface 334 of the tab 134 on the body 102 and the side surface 506 of the insert 104 are substantially planar in a particular configuration of the mounting device 100, when the mounting device 100 is coupled to the panel projection 702. It should be understood, however, that the tab 134 may be configured such that the surfaces 334, 506 are not planar (i.e., offset by a select distance), without departing from the scope of the present disclosure.

In some embodiments, the body 102 and the insert 104 are at a non-zero angle to one another when coupled together with the fastener 106. For example, the insert 104 may be set at an oblique angle that may be greater than approximately 90 degrees or less than approximately 90 degrees relative to the body 102. For instance, the insert 104 may be set at an obtuse angle relative to the body 102, as defined by an angle between the upper surface 300 of the body 102 and the side surface 506 of the insert 104.

In embodiments, the body 102 and/or the insert 104 is dimensioned to be able to support an auxiliary structure or component having a predetermined amount of weight. For example, the body 102 and/or the insert 104 may be dimensioned to collectively support the weight of an auxiliary structure or component. In other embodiments, apertures of the body 102 and/or the insert 104 (and the arms, legs, and/or walls in which the apertures are formed) are dimensioned to resist pullout of threading of a fastener from the apertures. In one non-limiting example, the width 400 of the arm 108 of the body 102 is of a thickness that it can receive the threading of a fastener 106 having a 17-millimeter diameter shaft 109 (and optionally an M8 head 107) and resist a pullout load of approximately 3000 lbs. In some instances, the thickness is approximately 0.433 inches.

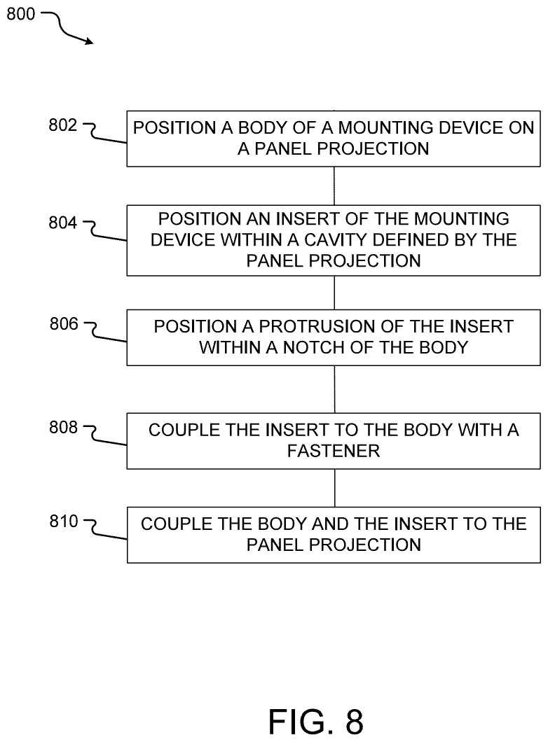

FIG. 8 is a method or process flow diagram 800 illustrating the operation of the mounting device 100, in accordance with one or more embodiments or the present disclosure. While a general order for the actions or steps of the method or process is shown in FIG. 8, the method or process can include more or fewer actions or steps or can arrange the order of the actions or steps differently (including simultaneously, substantially simultaneously, or sequentially) than those shown in FIG. 8. It is noted that the method or process shall be explained with reference to the components, devices, subassemblies, environments, etc. described in conjunction with FIGS. 1A-7B. For example, it is noted that the embodiments as illustrated in FIGS. 1A-7B should be understood as being directed to the embodiments described with respect to FIG. 8, and vice versa, without departing from the scope of the present disclosure.

In embodiments, a body of a mounting device is positioned 802 on a panel projection. The body 102 includes a throat 114 defined by one or more surfaces of the body 102. The throat 114 is positioned on the panel projection 702 (e.g., on an upper section 704 of the panel projection 702).

In embodiments, an insert of the mounting device is positioned 804 within a cavity defined by the panel projection. The insert 104 includes a trunk 118 that is positioned within the cavity 710 defined by the panel projection 702 (e.g., defined by the lower section 706 of the panel projection 702).

In embodiments, a protrusion of the insert is positioned 806 within a notch of the body. A protrusion 130 on a first leg 116 of the insert 104 is dimensioned to fit within a notch 126 in a first arm 108 of the body 102. It is noted that the positioning of the protrusion 130 within the notch 126 may be substantially simultaneously with, or after, the positioning of the trunk 118 within the cavity 710 defined by the panel projection 702.

In embodiments, the insert is coupled 808 to the body with a fastener. In some embodiments, a fastener 106 is inserted into an aperture 516 in a side surface 506 and exits a side surface 128 of the insert 104. The fastener 106 is then inserted into an aperture 312 in a side surface 306 of the body 102. For example, the aperture 312 may include complementary threading to at least a portion of the fastener 106.

In embodiments, the body and the insert are coupled 810 to the panel projection. Engaging the fastener 106 in the body 102 causes the throat 114 to draw onto the panel projection 702 (e.g., with the body 102 rotating in a clockwise motion). Engaging the fastener 106 also tightens the fastener 106 against the insert 104 to draw the trunk 118 (i.e., an upper surface 504 (or proximal end) of the trunk 118) into the panel projection 702 (e.g., with the insert 104 rotating in a counterclockwise motion). In general, engaging the fastener 106 causes the body 102 and the insert 104 to rotate in different directions from one another to secure against respective surfaces 704A, 706A of the panel projection 702.

It is noted that the drawing together may occur via a pivoting or rotating motion about an axis proximate to the interface between the pivot corner 344 of the body 102 and the pivot corner 532 of the insert 104. With the engagement of the fastener 106, the insert 104 may pivot or rotate relative to the body 102 via an axis proximate to the coupling of the notch 126 and the protrusion 130, such that the body 102 and the insert 104 rotates between a first orientation in which the insert 104 does not engage the panel projection 702 and a second orientation in which the insert 104 does engage the panel projection 702. In some instances, the pivoting or rotating of the insert 104 relative to the body 102 about the axis causes the surfaces 124, 128 to make contact. Thus, the mounting device 100 is secured to the panel projection 702.

Embodiments of the present disclosure are directed to the assembly of the mounting device 100 on the panel projection 702. However, it is contemplated that the mounting device 100 may be assembled prior to installation on the panel projection 702, and the assembled mounting device 100 is slid onto an accessible end of the panel projection 702, without departing from the scope of the present disclosure.

In this regard, advantages of the present disclosure include, but are not limited to, a mounting device for a metal panel. In particular, advantages of the present disclosure are also directed to a body and an insert for the mounting device. Advantages of the present disclosure are also directed to securing the body and the insert together with a fastener that engages the body and/or the insert. Advantages of the present disclosure are also directed to installing the mounting device on a panel projection of the metal panel, such that the body sits on the panel projection and the insert is positioned at least partially within the panel projection. Advantages of the present disclosure are also directed to pivoting or rotating the insert relative to the body (i.e., during coupling via the fastener) via engagement of a notch in the body by a protrusion on the insert, to cause the body and the insert to be secured to the panel projection. Advantages of the present disclosure are also directed to the throat of the body being contoured to conform to multiple different configurations of the panel projection. Still another advantage of the present disclosure is a mounting device comprising a body and an insert in which an upper surface of the body is generally planar and the body and the insert are coupled together by a fastener that extends through side surfaces of the body and the insert such that the planar upper surface of the body is free from projections to support objects to be secured to the mounting device.

As such, the advantages of the present disclosure are directed to the ability to couple the mounting device to a metal panel (i.e., such as one that cannot be punctured and/or otherwise modified through a force applied on the metal panel by the mounting device). The coupling of the mounting device to the metal panel occurs via the compression of portions of a panel projection of the metal panel between the body and the insert of the mounting device.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure described herein is capable of other embodiments and of being practiced or of being carried out in various ways. It is to be understood that the phraseology and terminology used herein is for the purpose of description and should not be regarded as limiting.

What is claimed is:

1. A mounting device for a metal panel, comprising:
a body comprising an arm with a first aperture, the body including at least one interior surface that defines a throat;
an insert comprising a leg and a trunk, the leg including a second aperture; and
a fastener insertable through the second aperture of the insert and into the first aperture of the body,
wherein insertion of the fastener into the second aperture of the insert and the first aperture of the body causes the throat of the body to engage a first surface of a panel projection of the metal panel when the mounting device is positioned on the metal panel, and
wherein insertion of the fastener into the second aperture of the insert and the first aperture of the body causes the trunk of the insert to engage a second surface within a cavity of the panel projection of the metal panel.

2. The mounting device of claim 1, wherein the arm of the body includes a notch, wherein the leg of the insert includes a protrusion, and wherein the protrusion is insertable into the notch of the body.

3. The mounting device of claim 1, wherein a first side surface of the arm of the body and a second side surface of the leg of the insert are set at an oblique angle when the throat is engaged to the first surface and the trunk is engaged to the second surface.

4. The mounting device of claim 1, wherein the throat comprises a base surface, wherein the base surface and a proximal end of the trunk define a gap in which the panel projection is positioned when the mounting device is installed on the metal panel.

5. The mounting device of claim 1, wherein the throat comprises a first side surface, a second side surface, a base surface, a third side surface, a fourth side surface, and a fifth side surface.

6. The mounting device of claim 5, wherein one or more of the first side surface, the second side surface, the base surface, the fourth side surface, and the fifth side surface engage the first surface of the panel projection of the metal panel when the mounting device is positioned on the metal panel, and wherein a proximal end of the trunk engages the second surface of the panel projection.

7. The mounting device of claim 5, wherein at least the base surface and the third side surface engage the first surface of the panel projection of the metal panel when the mounting device is positioned on the metal panel, and wherein a proximal end of the trunk engages the second surface of the panel projection.

8. The mounting device of claim 1, wherein the first aperture has threading that is complementary to threading on the fastener, wherein the threading of the fastener has a thread pitch, and wherein the first aperture has a length at least two times greater than the thread pitch.

9. The mounting device of claim 1, wherein the second aperture in the insert is an elongated slot.

10. The mounting device of claim 1, the body further comprising a wall with a third aperture for installing a structure onto the mounting device after the mounting device is installed on the panel projection of the metal panel.

11. The mounting device of claim 10, the body further comprising a second arm opposite the arm, wherein an upper surface of the wall and an exterior surface of the second arm are substantially perpendicular, and wherein the exterior surface of the second arm is substantially planar.

12. A mounting device for a metal panel, comprising:
a body comprising an arm with a notch, the body including at least one interior surface that defines a throat; and
an insert comprising a leg and a trunk, the leg including a protrusion,
wherein the body and the insert are rotatable between a first orientation and a second orientation when the protrusion is positioned within the notch of the body,
wherein the body and the insert being in the first orientation causes the insert to be disengaged from a panel projection of the metal panel, and
wherein the body and the insert being in the second orientation causes the throat of the body to engage a first surface of the panel projection, and the trunk of the insert to engage a second surface within a cavity of the panel projection of the metal panel.

13. The mounting device of claim 12, the body comprising a tab located above the arm, the tab including a lower surface that at least partially defines the notch.

14. The mounting device of claim 13, wherein an upper surface of the protrusion and a lower surface of the tab are set at an oblique angle when the protrusion is inserted in the notch and the body is in the first orientation.

15. The mounting device of claim 12, wherein the notch includes a first pivot corner, wherein the protrusion includes a second pivot corner, and wherein the first pivot corner and the second pivot corner engage during a rotating of the body and the insert between the first orientation and the second orientation about an axis proximate to the first pivot corner.

16. A mounting device to engage a panel projection extending from a metal panel, comprising:
a body including a first aperture that is threaded, a notch, and a throat;
an insert including a second aperture that is an elongated slot, a protrusion, and a trunk, wherein the protrusion is insertable into the notch of the body; and
a fastener insertable through the second aperture of the insert and into threaded engagement with the first aperture of the body,
wherein the body and the insert are rotatable between a first orientation and a second orientation when the protrusion is inserted into the notch,
wherein the body and the insert being in the first orientation causes a gap between an end of the trunk and a base surface of the body to be a first magnitude,
wherein the body and the insert being in the second orientation causes the gap between the end of the trunk and the base surface of the body to be a second magnitude that is less than the first magnitude,
wherein when the fastener is inserted through the second aperture of the insert and into threaded engagement with the first aperture of the body, rotation of the fastener causes the body and the insert to move into the first orientation.

17. The mounting device of claim 16, wherein an arm of the body includes the first aperture and the notch, and wherein a leg of the insert includes the second aperture and the protrusion.

18. The mounting device of claim 17, further comprising a tab located above the arm, the tab including a lower surface that at least partially defines the notch.

19. The mounting device of claim 18, wherein an upper surface of the protrusion is set at an oblique angle to a first side surface of the leg, and wherein a lower surface of the tab is set at an oblique angle to an upper surface of the body.

20. The mounting device of claim 16, wherein the fastener has exterior threading with a thread pitch, and wherein the first aperture has a length at least two times greater than the thread pitch.
